(19) United States
(12) Patent Application Publication
(10) Pub. No.: US 2014/0308427 A1
(43) Pub. Date: Oct. 16, 2014

(54) COMPOSITION

(71) Applicants: Brad Alexander Forrest, New South Wales (AU); Allan Torben Bech, Brabrand (DK); Jens Mogens Nielsen, Galten (DK)

(72) Inventors: Brad Alexander Forrest, New South Wales (AU); Allan Torben Bech, Brabrand (DK); Jens Mogens Nielsen, Galten (DK)

(73) Assignee: Dupont Nutrition Biosciences APS, Copenhagen K (DK)

(21) Appl. No.: 14/234,107

(22) PCT Filed: Jul. 25, 2012
(86) PCT No.: PCT/IB2012/053787

§ 371 Date: Jun. 26, 2014

(30) Foreign Application Priority Data
Jul. 25, 2011 (GB) 1112729.7
May 22, 2012 (GB) 1208992.6

(51) Int. Cl. A23D 9/06

(52) U.S. Cl. CPC A23D 9/06
USPC 426/610; 554/2; 554/3

(57) ABSTRACT

There is provided a palm olein composition comprising: (a) palm olein oil (b) (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof.

The present invention relates to a composition. In particular, the present invention relates to a palm olein oil composition containing a material that inhibits crystallisation of fat present in the palm olein oil. The invention further relates to processes for inhibiting crystallisation of said fat and to use of the crystallisation inhibitor.

### INTRODUCTION

Palm olein is globally used as cooking oil. Palm olein having an iodine value of 56 or more is often used in cooking oils in many Asian countries, but also to some extent in South America, especially in domestic situations. One of the quality criteria for cooking oil is the ability of the oil to stay crystal-free during storage, for example in a supermarket. High premium cooking oil is mostly free of any visible crystal formation during long storage time. Initial crystallisation is commonly, although not exclusively, visible as a thin fat crystal layer at the bottom.

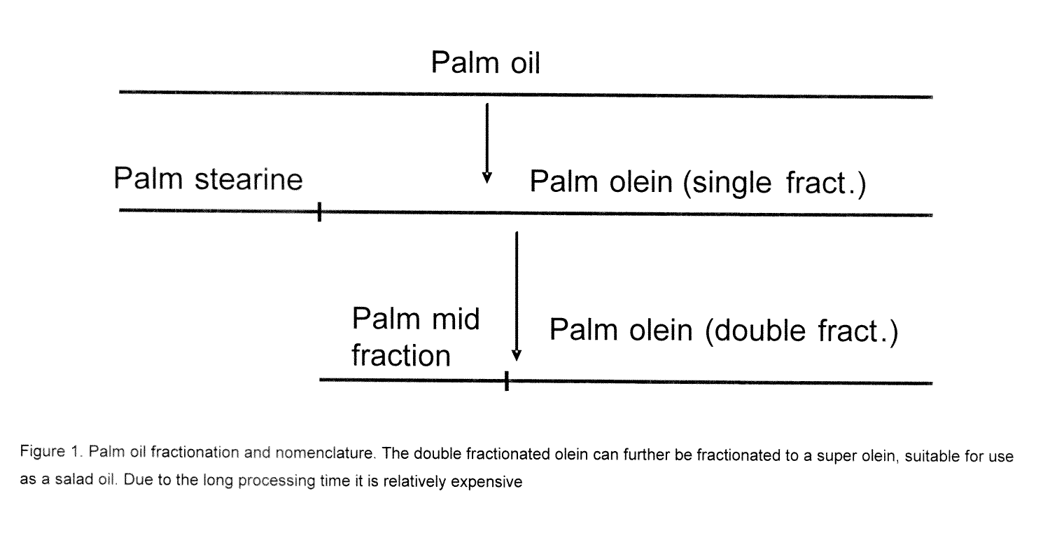

Palm olein is produced from palm oil by fractionation usually by dry fractionations where no solvents are used. Palm olein is the liquid fraction of palm oil and the high melting triglycerides such as PPP (tripalmitin) are removed from or at least reduced to a low level in the olein fraction. This is illustrated in FIG. 1, which shows the different palm oil fractions. It is noted that the first olein (single fractionated olein) can be fractionated further to a palm mid fraction and double fractionated olein. The double fractionated olein has less tendency to crystallise than the single fractionated olein at typical storage temperature (of approximately 20° C.).

Traditionally, the olein fraction has been the valuable part of palm oil and oil producers tend to increase the olein yield during fractionation by minimising the amount of palm stearine that is removed during fractionation. This however tends to increase the risk of crystallisation in the palm olein. Hence in practice it is a compromise between yield and cooking oil quality. This balance is often addressed to some degree with the introduction of anticrystallisers into the oil. Diglycerides are also commonly found in palm oil, and can concentrate into the olein fraction where they act to increase the cloud point. Anticrystallizers can be useful in lengthening the period of clarity obtained from such diglyceride containing oleins.

For many years sorbitan tristearate (STS) has been sold as an anticrystalliser in cooking oil. The window where STS provides satisfactory results, is however quite narrow. Below 20° C. STS functionality progressively decreases. In well fractionated olein, STS can delay the onset of crystallisation by a factor of 10. However, the effect depends very much on the olein composition. A further improvement in inhibition of fat crystallisation may be obtained by combining STS with soy lecithin. However, due to the colouring effect of lecithin in cooking oil during heating, the inclusion of lecithin is not a practical solution. Yet further improvement can be obtained by blending palm olein with liquid oils such as soyabean oil. It is known in the art that such blends can also be treated with STS in order to extend the time before noticeable crystallisation occurs.

However, such liquid oils are usually more expensive than palm olein and it would be desirable to use less of them. To some extent STS allows this.

### SUMMARY OF INVENTION

In a first aspect the present invention provides a palm olein composition comprising:

(a) palm olein oil

(b) (i) a lactic acid ester selected from an ester of lactic acid and a C12 to C22 fatty acid, salts thereof and mixtures thereof; or
(ii) a fumaric acid ester selected from an ester of fumaric acid and a C12 to C22 fatty alcohol, salts thereof. and mixtures thereof.

In a second aspect the present invention provides a process for inhibiting crystallisation of triglyceride in palm olein oil, the process comprising the step of combining with the palm olein oil, (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol. salts thereof and mixtures thereof.

In a third aspect the present invention provides use of (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof,

for inhibiting crystallisation of triglyceride in palm olein oil.

The present invention provides a crystallisation inhibitor for the inhibition of crystallisation of triglycerides in palm olein, In particular the present inhibitor, namely (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof, provides inhibition of crystallisation of triglycerides in palm olein.

It will be understood by one skilled in the art that in the context of the present invention the term “inhibition” or “inhibitor” in relation to crystallisation means that the material reduces the amount of triglyceride that crystallizes in a given period and/or increases the time before which a given amount of triglyceride has crystallized. Although it is desired that all triglyceride crystallisation is prevented during likely storage periods, this is not an essential requirement for a crystallisation inhibitor.

The present inventors have particularly found that not only may the presently described lactic acid esters and fumaric acid esters inhibit crystallisation of triglyceride in palm olein oil, they may also enhance the effect of STS as a crystallisation inhibitor. This was unexpected. Thus not only do the presently described lactic acid esters and fumaric acid esters act as a crystallisation inhibitor themselves, but they may also be combined with the known inhibitor STS to provide a beneficial effect. In this aspect the present invention provides
a palm olein composition comprising:
   (a) palm olein oil;
   (b) (i) a lactic acid ester selected from an ester of lactic acid and a C12 to C22 fatty acid, salts thereof and mixtures thereof; or
      (ii) a fumaric acid ester selected from an ester of fumaric acid and a C12 to C22 fatty alcohol, salts thereof. and mixtures thereof.
   (c) sorbitan tristearate.
a process for inhibiting crystallisation of triglyceride in palm o e n the process comprising the step of combining
   (a) (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof, and
   (b) sorbitan tristearate, with the palm olein oil use of (a) (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof, and (b) sorbitan tristearate for inhibiting crystallisation of triglyceride in palm olein oil.

For ease of reference, these and further aspects of the present invention are now discussed under appropriate section headings. However, the teachings under each section are not necessarily limited to each particular section.

### DETAILED DESCRIPTION

As discussed herein, the present invention provides a palm olein composition comprising:

(a) palm olein oil

(b) (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof.

Palm Olein Oil

Palm oil is an edible plant oil derived from the pulp of the fruit of the oil palm Elaeis guineensis. Palm oil is fractionated with crystallisation and separation processes to obtain a solid stearine fraction and a liquid olein fraction. Palm olein oil as referred to herein is a liquid fraction of fractionated palm oil, such as the liquid fraction of single or double fractionated palm oil, Palm olein oil as referred to herein may be a liquid fraction of fractionated palm oil having an iodine value of 56 or more, such as an iodine value of 60 or more.

In one preferred aspect the palm olein is double fractionated.

A preferred palm olein oil is deodorised palm olein oil or refined palm olein oil. The palm olein may be refined by chemical means or by physical means. Typical chemical refining comprises steps of contacting the palm olein with caustic, washing the caustic containing material, bleaching and then deodorising. Typical physical refining comprises the steps of bleaching the palm olein, deodorising and then “stripping off” under a vacuum with steam injection. A preferred palm olein oil is deodorised palm olein oil. When the palm olein oil is deodorised palm olein oil, the ester of (i) lactic acid or fumaric acid and (ii) a C12 to C22 fatty acid, or a salt thereof, may be added to the oil before or after deodorization. It is preferred to add the ester/salt after deodorization because the ester/salt may have a tendency to act as an interesterification catalyst.

The palm olein oil may in one aspect be the sole oil component of the palm olein composition. However, in other aspects the palm olein composition may contain one or more oils in addition to the palm olein oil. For example, the one or more oils may be selected from other ‘soft oils’. Examples of soft oils are moringa oil, soy oil, cottonseed oil, canola oil, rapeseed oil (such as high oleic rapeseed oil, that is rapeseed oil containing at least 82% oleic acid based on the total weight of fatty acids; and such as low erucic acid rapeseed oil or high erucic acid rapeseed oil, low erucic acid rapeseed oil may also be known as canola oil), peanut oil, rice bran oil (such as dewaxed rice bran oil), corn oil, safflower oil, sunflower oil (such high oleic sunflower oil, that is sunflower oil containing at least 82% oleic acid based on the total weight of fatty acids), linseed oil, olive oil, peanut oil and mixtures thereof.

When the palm olein oil is combined with one or more further oils (such as a soft oil) the oils may be combined in any suitable ratio. Particularly preferred weight ratios of soft oil to palm olein are 9:1 to 0:1, such as 9:1 to 1:9, such as 8:1 to 1:8, such as 7:1 to 1:7, such as 6:1 to 1:6, such as 5:1 to 1:5, such as 4:1 to 1:4, such as 3:1 to 1:3, such as 2:1 to 1:2, such as approximately 1:1, In one aspect weight ratios of soft oil to palm olein are 1:1 to 0:1, such as 1:2 to 0:1, such as 1:3 to 0:1, such as 1:3 to 0:1, such as 1:4 to 0:1, such as 1:5 to 0:1, such as 1:6 to 0:1, such as 1:7 to 0:1, such as 1:8 to 0:1, such as 1′9 to 01.

Lactic Acid/Fumaric Acid

The ester used in the present invention is an ester of lactic acid or fumaric acid. Lactic acid is also known as 2-hydroxypropanoic acid, Fumaric acid is also known as (E)-butenedioic acid,

In one preferred aspect the ester is a lactic acid ester selected fro an ester of lactic acid and a C12 to C22 fatty acid, salts thereof and mixtures thereof.

In one preferred aspect the ester is a fumaric acid ester selected from an ester of fumaric acid and a C12 to C22 fatty alcohol, salts thereof and mixtures thereof.

In one aspect the ester is a mixture of a lactic acid ester described herein and a fumaric acid ester described herein.

Fatty Acid

The fatty acid used to prepare the lactic acid ester of the present invention is a C12 to C22 fatty acid.

In one aspect the fatty acid is a C12 to C22 fatty acid. Preferably the fatty acid is a C16 to C22 fatty acid. Preferably the fatty acid is a C18 to C22 fatty acid. Preferably the fatty acid is a C16 to C20 fatty acid. Preferably the fatty acid is a C18 to C20 fatty acid. Preferably the fatty acid is a C16 to C18 fatty acid. In one aspect the fatty acid is a C18 fatty acid. In one aspect the fatty acid is a C16 fatty acid. Preferably the fatty acid is a mixture of C16 fatty acid and C18 fatty acid.

In one aspect the fatty acid is a C12 fatty acid. In one aspect the fatty acid is a C14 fatty acid. In one aspect the fatty acid is a C16 fatty acid. In one aspect the fatty acid is a C18 fatty acid. In one aspect the fatty acid is a C20 fatty acid. In one aspect the fatty acid is a C22 fatty acid.

The fatty acid may be any suitable C12 to C22 to provide the desired crystallisation inhibition. The fatty acid may be a saturated or unsaturated fatty acid. If the fatty acid is unsaturated it may have one or more degrees of unsaturation, for example one, two or three degrees of unsaturation (that is it contains, for example, one two or three double bonds). In respect of the one or more double bonds, each may independently be in the cis configuration or in the trans configuration. In one aspect each double bond is in the trans configuration. In one aspect each double bond is in the cis configuration. In one preferred aspect, the fatty acid is a saturated fatty acid.

The fatty acid may be a straight chain fatty acid or a branched chain fatty acid. In one aspect the fatty acid may be a straight chain fatty acid, which may be saturated or unsaturated.

In a preferred aspect the fatty acid is a straight chain saturated fatty acid. In a preferred aspect the fatty acid is a saturated fatty acid.

In a preferred aspect the fatty acid may be substituted by one or more hydroxyl groups. This fatty acid may be a saturated or unsaturated fatty acid. An example of such a fatty acid is ricinoleic acid.

Among the fatty acids that may be used in the present invention are oleic acid, stearic acid, lauric acid, palmitic acid and behenic acid. Particularly preferred fatty acids are stearic acid, palmitic and behenic acid, preferably stearic acid and palmitic acid. Most preferred is stearic acid. Highly preferred saturated fatty acids are palmitic acid, stearic acid or mixture thereof. In one aspect the fatty acid comprises at least oleic acid. In one aspect the fatty acid comprises at least lauric acid. In one aspect the fatty acid comprises at least palmitic acid. In one aspect the fatty acid comprises at least behenic acid. In one preferred aspect the fatty acid comprises at least stearic acid. In one preferred aspect the fatty acid is at least palmitic acid. In one preferred aspect the fatty acid comprises a mixture of stearic acid and palmitic acid.

Fatty Alcohol

The fatty alcohol used to prepare the fumaric acid ester of the present invention is a C12 to C22 fatty alcohol. As will be understood by one skilled in the art, a fatty alcohol is typically a long chain of alkyl group of the formula CH₃—(CH₂)ₙ—CH₂OH, where n determines the chain length. In the present invention wherein the fatty alcohol is a C12 to C22 fatty alcohol, n would be from 10 to 20.

In one aspect the fatty alcohol is a C12 to C22 fatty alcohol. Preferably the fatty alcohol is a C16 to C22 fatty alcohol. Preferably the fatty alcohol is a C18 to C22 fatty alcohol. Preferably the fatty alcohol is a C16 to C20 fatty alcohol, Preferably the fatty alcohol is a C18 to C20 fatty alcohol. Preferably the fatty alcohol is a C16 to C18 fatty alcohol. In one aspect the fatty alcohol is a C18 fatty alcohol, In one aspect the fatty alcohol is a C16 fatty alcohol. Preferably the fatty alcohol is a mixture of C16 fatty alcohol and C18 fatty alcohol.

In one aspect the fatty alcohol is a C12 fatty alcohol. In one aspect the fatty alcohol is a C14 fatty alcohol. In one aspect the fatty alcohol is a C16 fatty alcohol. In one aspect the fatty alcohol is a C18 fatty alcohol. In one aspect the fatty alcohol is a C20 fatty alcohol. In one aspect the fatty alcohol is a C22 fatty alcohol.

The fatty alcohol may be any suitable C12 to C22 to provide the desired crystallisation inhibition. The fatty alcohol may be a saturated or unsaturated fatty alcohol. If the fatty alcohol is unsaturated it may have one or more degrees of unsaturation, for example one, two or three degrees of unsaturation (that is it contains, for example, one two or three double bonds). In respect of the one or more double bonds, each may independently be in the cis configuration or in the trans configuration. In one aspect each double bond is in the trans configuration. In one aspect each double bond is in the cis configuration. In one preferred aspect, the fatty alcohol is a saturated fatty alcohol.

The fatty alcohol may be a straight chain fatty alcohol or a branched chain fatty alcohol. In one aspect the fatty alcohol may be a straight chain fatty alcohol, which may be saturated or unsaturated.

In a preferred aspect the fatty alcohol is a straight chain saturated fatty alcohol. In a preferred aspect the fatty alcohol is a saturated fatty alcohol.

Among the fatty alcohols that may be used in the present invention are oleyl alcohol, stearyl alcohol, lauryl alcohol, palmityl alcohol and behenyl alcohol. Particularly preferred fatty alcohols are stearyl alcohol, palmityl and behenyl alcohol, preferably stearyl alcohol and palmityl alcohol, Most preferred is stearyl alcohol. Highly preferred saturated fatty alcohols are palmityl alcohol, stearyl alcohol or mixture thereof. In one aspect the fatty alcohol comprises at least oleyl alcohol. In one aspect the fatty alcohol comprises at least lauryl alcohol, In one aspect the fatty alcohol comprises at least palmityl alcohol. In one aspect the fatty alcohol comprises at least behenyl alcohol. In one preferred aspect the fatty alcohol comprises at least stearyl alcohol. In one preferred aspect the fatty alcohol is at least palmityl alcohol. In one preferred aspect the fatty alcohol comprises a mixture of stearyl alcohol and palmityl alcohol.

Salt

The ester of the present invention formed from lactic acid or fumaric acid may, as appreciated by one skilled in the art, have an acid group. The acid group of the ester may in one preferred aspect be in the form of a salt. The salt may be any suitable metal salt. In particular the salt may be any metal salt of a Group I (alkali metal) or Group II (alkaline earth metal). In one preferred aspect the salt is a sodium, calcium or potassium salt of the ester of lactic acid or fumaric acid and a C12 to C22 fatty acid. In one aspect the salt is a potassium salt. In a preferred aspect the salt is a sodium salt. In one aspect the salt is a calcium salt.

Ester

It will be appreciated by one skilled in the art that the esters of the present invention may be denoted by the following structures. In respect of the lactic acid esters, the structure is:

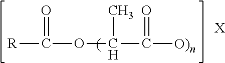

wherein n is from 1 to 5. X is a metal ion or H, R is a C12 to C22 fatty acid residue.

Preferably n is from 1 to 3. More preferably n is approximately 2.

X is preferably selected from H, Na, Ca and K. In one aspect X is K. X is more preferably selected from Na and Ca.

In respect of the fumaric acid esters, the structure is:

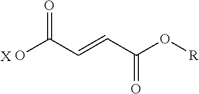

wherein X is a e a ion or H, R is a C12 to C22 fatty alcohol X is preferably selected from H, Na, Ca and K. X is more preferably selected from Na and Ca.

In a preferred embodiment the ester is selected from the group consisting of sodium stearoyl lactylate, potassium stearoyl lactylate, calcium stearoyl lactylate, sodium oleyl lactylate, sodium palmitoyl lactylate, sodium stearoyl fumarate, sodium lauryl lactylate, sodium behenoyl lactylate, and mixtures thereof.

Thus in one aspect the present invention provides a palm olein composition comprising:

(a) palm olein oil

(b) a compound selected from the group consisting of sodium stearoyl lactylate, potassium stearoyl lactylate, calcium stearoyl lactylate, sodium oleyl lactylate, sodium palmitoyl lactylate, sodium stearoyl fumarate, sodium lauryl lactylate, sodium behenoyl lactylate, and mixtures thereof.

In a second aspect the present invention provides a process for inhibiting crystallisation of triglyceride in palm olein oil, the process comprising the step of combining with the palm olein oil, a compound selected from the group consisting of sodium stearoyl lactylate, potassium stearoyl lactylate, calcium stearoyl lactylate, sodium oleyl lactylate, sodium palmitoyl lactylate, sodium stearoyl fumarate, sodium lauryl lactylate, sodium behenoyl lactylate, and mixtures thereof.

In a preferred embodiment the ester is selected from the group consisting of sodium stearoyl lactylate, potassium stearoyl lactylate, calcium stearoyl lactylate, sodium palmitoyl lactylate, sodium lauryl lactylate, sodium behenoyl lactylate, and mixtures thereof.

In a highly preferred embodiment the ester is sodium stearoyl lactylate.

In one aspect the ester is a sodium, calcium or potassium salt of the ester of lactic acid and a C12 fatty acid. In one aspect the ester is a sodium, calcium or potassium salt of the ester of lactic acid and a C14 fatty acid, In one aspect the ester is a sodium, calcium or potassium salt of the ester of lactic acid and a C16 fatty acid. In one aspect the ester is a sodium, calcium or potassium salt of the ester of lactic acid and a C18 fatty acid. In one aspect the ester is a sodium, calcium or potassium salt of the ester of lactic acid and a C20 fatty acid. In one aspect the ester is a sodium, calcium or potassium salt of the ester of lactic acid and a C22 fatty acid.

In one aspect the ester is a sodium, calcium or potassium salt of the ester of fumaric acid and a C12 fatty alcohol. In one aspect the ester is a sodium, calcium or potassium salt of the ester of fumaric acid and a C14 fatty alcohol. In one aspect the ester is a sodium, calcium or potassium salt of the ester of fumaric acid and a C16 fatty alcohol. In one aspect the ester is a sodium, calcium or potassium salt of the ester of fumaric acid and a C18 fatty alcohol. In one aspect the ester is a sodium, calcium or potassium salt of the ester of fumaric acid and a C20 fatty alcohol. In one aspect the ester is a sodium, calcium or potassium salt of the ester of fumaric acid and a C22 fatty alcohol.

In one aspect the ester is a sodium or calcium salt of the ester of lactic acid and a C12 fatty acid. In one aspect the ester is a sodium or calcium salt of the ester of lactic acid and a C14 fatty acid. In one aspect the ester is a sodium or calcium salt of the ester of lactic acid and a C16 fatty acid. In one aspect the ester is a sodium or calcium salt of the ester of lactic acid and a C18 fatty acid. In one aspect the ester is a sodium or calcium salt of the ester of lactic acid and a C20 fatty acid. In one aspect the ester is a sodium or calcium salt of the ester of lactic acid and a C22 fatty acid.

In one aspect the ester is a sodium or calcium salt of the ester of fumaric acid and a C12 fatty alcohol. In one aspect the ester is a sodium or calcium salt of the ester of fumaric acid and a C14 fatty alcohol. In one aspect the ester is a sodium or calcium salt of the ester of fumaric acid and a C16 fatty alcohol. In one aspect the ester is a sodium or calcium salt of the ester of fumaric acid and a C18 fatty alcohol, In one aspect the ester is a sodium or calcium salt of the ester of fumaric acid and a C20 fatty alcohol, In one aspect the ester is a sodium or calcium salt of the ester of fumaric acid and a C22 fatty alcohol,

In one aspect the ester is a sodium salt of the ester of lactic acid and a C12 fatty acid. In one aspect the ester is a sodium salt of the ester of lactic acid and a C14 fatty acid. In one aspect the ester is a sodium salt of the ester of lactic acid and a C16 fatty acid. In one aspect the ester is a sodium salt of the ester of lactic acid and a C18 fatty acid, In one aspect the ester is a sodium salt of the ester of lactic acid and a C20 fatty acid. In one aspect the ester is a sodium salt of the ester of lactic acid and a C22 fatty acid.

In one aspect the ester is a sodium salt of the ester of fumaric acid and a C12 fatty alcohol. In one aspect the ester is a sodium salt of the ester of fumaric acid and a C14 fatty alcohol. In one aspect the ester is a sodium salt of the ester of fumaric acid and a C16 fatty alcohol. In one aspect the ester is a sodium salt of the ester of fumaric acid and a C18 fatty alcohol. In one aspect the ester is a sodium salt of the ester of fumaric acid and a C20 fatty alcohol. In one aspect the ester is a sodium salt of the ester of fumaric acid and a C22 fatty alcohol.

The ester or salt thereof should of course be present in any suitable amount to provide the desired crystallisation inhibition. The minimum amount may be readily determined by one skilled in the art. For example, The ester or salt thereof may be present in an amount of at least 0.001 wt %, such in an amount of at least 0.002 wt %, such in an amount of at least 0.003 wt %, such in an amount of at least 0.005 wt %, such in an amount of at least 0.007 wt %, such in an amount of at least 0.01 wt %, such in an amount of at least 0.02 wt % based on the weight of palm olein oil, such in an amount of at least 0.05 wt % based on the weight of palm olein oil, such in an amount of at least 0.1 wt % based on the weight of palm olein oil. It will be appreciated by one skilled in the art that below a certain level the ester or salt thereof will not have the desired crystallisation inhibitory effect. The amount of ester or salt thereof required may be readily determined by one skilled in the art by comparison of the palm olein in accordance with the experimental methods described herein with the ester or salt thereof present at varying amounts.

It may be desirable for the ester or salt thereof to be present in maximum amounts. The maximum amount may be determined by one or more considerations. One important consideration is the amount permitted by the statutes and regulations of any country in which the product is to be sold. The maximum amount may be determined by one skilled in the art dependent on the relevant conditions_{;} such as statute and regulation. so For example, the ester or salt thereof may be present in an amount of no greater than 1.0 wt %, such in an amount of no greater than 0.7 wt %, such in an amount of no greater than 0.5 wt %, such in an amount of no greater than 0.3 wt %, such in an amount of no greater than 0.2 wt %. such in an amount of no greater than 0.1 wt %, such as in an amount of no greater than 0.05 wt %, such as in an amount of no greater than 0.04 wt %. such as in an amount of no greater than 0,03 wt %, such as in an amount of no greater than 0.02 wt %, such as in an amount of no greater than 0.01 wt % based on the weight of palm olein oil.

Further Components

The palm olein composition may optionally contain one or more further components in addition to the ester or salt thereof. These components may be for example antioxidants, antispattering agents, emulsifiers (such as CITREMs), lecithin, and flavourings. Antioxidants that may be present in the composition include GRINDOX 204 (available from DuPont formerly Danisco A/S), GUARDIAN Rosemary Extract 08 (available from DuPont formerly Danisco A/S), GUARDIAN Rosemary Extract 201 (available from DuPont formerly Danisco A/S), butylated hydroxyanisole, tocopherols and mixtures thereof.

In one preferred aspect, and as discussed herein, the palm olein composition further comprises (c) sorbitan tristearate (STS). If present the STS should of course be present in any suitable amount to provide the desired effect, such as improved crystallisation inhibition. This amount may be readily determined by one skilled in the art. For example, the STS may be present in an amount of at least 0.001 wt %, such in an amount of at least 0.002 wt %, such in an amount of at least 0.003 wt %, such in an amount of at least 0.005 wt %, such in an amount of at least 0.007 wt %, such in an amount of at least 0.01 wt %, such in an amount of at least 0.02 wt %, such in an amount of at least 0.04 wt %, such in an amount of at least 0.06 wt %, such in an amount of at least 0.08 wt % based on the weight of palm olein oil, such in an amount of at least 0.1 wt % based on the weight of palm olein oil, such in an amount of at least 0.15 wt % based on the weight of palm olein oil.

It may be desirable for STS, if present, to be present in maximum amounts. These may be determined by one skilled in the art. For example, the STS may be present in an amount of no greater than 1.0 wt %, such as in an amount of no greater than 0.7 wt %, such as in an amount of no greater than 0.5 wt %, such as in an amount of no greater than 0.3 wt %, such as in an amount of no greater than 0.2 wt %©, such as in an amount of no greater than 0.1 wt %, such as in an amount of no greater than 0.05 wt %, such as in an amount of no greater than 0.03 wt %, such as in an amount of no greater than 0.02 wt %, such as in an amount of no greater than 0.01 wt % based on the weight of palm olein oil.

Preferred amounts of ester or salt thereof and STS are given in the table below. For each preferred amount of ester or salt thereof, the preferred amounts of STS are listed in the adjoining column.

| Ester or Salt | | |
|---|---|---|
| thereof | | |
| (based on | | |
| the weight | | |
| of palm | STS | |
| olein oil) | (based on the weight of palm olein oil) | |
| at least% | at least 0.001 wt % | at least 0.002 wt % |
| 0.001 wt | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| at least% | at least 0.001 wt % | at least 0.002 wt % |
| 0.002 wt | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| at least% | at least 0.001 wt % | at least 0.002 wt % |
| 0.003 wt | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| at least% | at least 0.001 wt % | at least 0.002 wt % |
| 0.005 wt | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| at least% | at least 0.001 wt % | at least 0.002 wt % |
| 0.007 wt | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| at least | at least 0.001 wt % | at least 0.002 wt % |
| 0.01 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| at least | at least 0.001 wt % | at least 0.002 wt % |
| 0.02 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| no greater than | at least 0.001 wt % | at least 0.002 wt % |
| 1.0 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| no greater than | at least 0.001 wt % | at least 0.002 wt % |
| 0.7 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| no greater than | at least 0.001 wt % | at least 0.002 wt % |
| 0.5 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| no greater than | at least 0.001 wt % | at least 0.002 wt % |
| 0.3 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| no greater than | at least 0.001 wt % | at least 0.002 wt % |
| 0.2 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| no greater than | at least 0.001 wt % | at least 0.002 wt % |
| 0.1 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| no greater than | at least 0.001 wt % | at least 0.002 wt % |
| 0.05 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| no greater than | at least 0.001 wt % | at least 0.002 wt % |
| 0.03 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| no greater than | at least 0.001 wt % | at least 0.002 wt % |
| 0.02 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |
| no greater than | at least 0.001 wt % | at least 0.002 wt % |
| 0.01 wt % | at least 0.003 wt % | at least 0.005 wt % |
| | at least 0.007 wt % | at least 0.01 wt % |
| | at least 0.02 wt % | |
| | no greater than 1.0 wt % | no greater than 0.7 wt % |
| | no greater than 0.5 wt % | no greater than 0.3 wt % |
| | no greater than 0.2 wt % | no greater than 0.1 wt % |
| | no greater than 0.05 wt % | no greater than 0.03 wt % |
| | no greater than 0.02 wt % | no greater than 0.01 wt % |

If STS is present, the ratio of STS:Ester/Salt may be from 15:1 to 5:1, such as 12:1 to 7:1, such as 10:1 to 7:1, such as 9:1 to 7:1, such as approximately 8:1.

If STS is present, in one aspect (for example when the palm olein is stored at a temperature of at least 10° C.) it is preferred that the ratio of STS:Ester/Salt is from 15:1 to 1:15, such as 15:1 to 1:14, such as 15:1 to 1:13, such as 15:1 to 1:12, such as 15:1 to 1:11, such as 15:1 to 1:10, such as 15:1 to 1:9, such as 15:1 to 1:8, such as 15:1 to 1:7, such as 15:1 to 1:6, such as 15:1 to 1:5, such as 15:1 to 1:4, such as 15:1 to 1:3, such as 15:1 to 1:2, such as 15:1 to 1:1, such as 14:1 to 1:15, such as 13:1 to 1:15, such as 12:1 to 1:15, such as 11:1 to 1:15, such as 10:1 to 1:15, such as 9:1 to 1:15, such as 8:1 to 1:15, such as 7:1 to 1:15, such as 6:1 to 1:15, such as 5:1 to 1:15, such as 4:1 to 1:15, such as 3:1 to 1:15, such as 2:1 to 1:15, such as 1:1 to 1:15, such as 14:1 to 1:5, such as 13:1 to 1:5, such as 12:1 to 1:5, such as 11:1 to 1:5, such as 10:1 to 1:5, such as 9:1 to 1:5, such as 8:1 to 1:5, such as 7:1 to 1:5, such as 6:1 to 1:5, such as 5:1 to 1:5, such as 5:1 to 1:4, such as 5:1 to 1:3, such as 5:1 to 1:2, such as 5:1 to 1:1, such as 4:1 to 1:2, such as 3:1 to 1:2, such as 2:1 to 1:2, such as 2:1 to 1:1, such as 4:1 to 1:1, such as 3:1 to 1:1, such as 2:1 to 1:1, such as 2.5:1 to 1.5:1 such as approximately 2:1.

If STS is present, in one aspect (for example when the palm olein is stored at a temperature of at least 10° C.) it is preferred that the ratio of STS:Ester/Salt is from 15:1 to 1:5, such as 15:1 to 1:4, such as 15:1 to 1:3, such as 15:1 to 1:2, such as 15:1 to 1:1, such as 14:1 to 1:5, such as 13:1 to 1:5, such as 12:1 to 1:5, such as 11:1 to 1:5, such as 10:1 to 1:5. such as 9:1 to 1:5, such as 8:1 to 1:5, such as 71 to 1:5, such as 6:1 to 1:5, such as 5:1 to 1:5, such as 5:1 to 1:4, such as 5:1 to 1:3, such as 5:1 to 1:2, such as 5:1 to 1:1, such as 4:1 to 1:2, such as 3:1 to 1:2, such as 2:1 to 1:2, such as 2:1 to 1:1, such as 4:1 to 1:1, such as 31 to 1:1, such as 2:1 to 1:1, such as 2.5:1 to 1 5:1 such as approximately 2:1.

If STS is present, in one aspect (for example when the palm olein is stored at a temperature of approximately 0° C.) it is preferred that the ratio of STS:Ester/Salt is from 15:1 to 1:15, such as 14:1 to 1:15, such as 13:1 to 1:15, such as 12:1 to 1:15, such as 11:1 to 1:15, such as 10:1 to 1:15, such as 9:1 to 1:15, such as 8:1 to 1:15, such as 7:1 to 1:15, such as 6:1 to 1:15, such as 5:1 to 1:15, such as 4:1 to 1:15, such as 3:1 to 1:15, such as 2:1 to 1:15, such as 1:1 to 1:15, such as 1:1 to 1:14, such as 1:1 to 1:13, such as 1:1 to 1:12, such as 1:1 to 1:11, such as 1:1 to 1:10, such as 1:1 to 1:9, such as 1:2 to 1:14, such as 1:3 to 1:13, such as 1:4 to 1:12, such as 1:5 to 1:12, such as 1:6 to 1:12, such as 1:7 to 1:11, such as 1:8 to 1:10, such as approximately 1:9.

If STS is present, it is preferred that the amounts of STS and Ester/Salt based on the combined amount of STS and Ester/Salt are selected from the following:

| Ester/Salt (wt %) | STS (wt %) |
|---|---|
| 1-20 | 80-99 |
| 1-15 | 85-99 |
| 1-10 | 90-99 |
| 2-10 | 90-98 |
| 2-8 | 92-98 |
| 4-6 | 94-96 |

If STS is present, the combined STS and Ester/Salt may be dosed into the palm olein in a total combined amount of 0.01 to 0.5 wt % based on the palm olein, such as in a total combined amount of 0.01 to 0.4 wt % based on the palm olein, such as in a total combined amount of 0.01 to 0.3 wt % based on the palm olein, such as in a total combined amount of 0.01 to 0,2 wt % based on the palm olein, such as in a total combined amount of 0.01 to 0.1 wt % based on the palm olein, such as in a total combined amount of 0.02 to 0.1 wt % based on the palm olein, such as in a total combined amount of 0,04 to 0.1 wt % based on the palm olein, such as in a total combined amount of 0.05 to 0.1 wt % based on the palm olein. Preferably the combined STS and Ester/Salt are dosed into the palm olein in a total combined amount of 0.06 to 0.08 wt % based on the palm olein,

If STS is present, it is preferred that the combined STS and Ester/Salt are dosed into the palm olein in a total combined amount of 0.001 to 0.5 wt % based on the palm olein, such as in a total combined amount of 0.001 to 0.4 wt % based on the palm olein, such as in a total combined amount of 0.001 to 0.3 wt % based on the palm olein, such as in a total combined amount of 0.001 to 0.2 wt % based on the palm olein, such as in a total combined amount of 0.002 to 0.2 wt % based on the palm olein, such as in a total combined amount of 0.003 to 0.2 wt % based on the palm olein, such as in a total combined amount of 0.004 to 0.2 wt % based on the palm olein, such as in a total combined amount of 0.005 to 0.2 wt % based on the palm olein, such as in a total combined amount of 0.006 to 0.2 wt % based on the palm olein, such as in a total combined amount of 0.007 to 0.2 wt % based on the palm olein, such as in a total combined amount of 0.008 to 0.2 wt % based on the palm olein, such as in a total combined amount of 0.009 to 0.2 wt % based on the palm olein, such as in a total combined amount of 0.01 to 0.2 wt % based on the palm olein, such as in a total combined amount of 0.01 to 0.15 wt % based on the palm olein, such as in a total combined amount of 0.01 to 0.1 wt % based on the palm olein, such as in a total combined amount of 0.01 to 0.09 wt % based on the palm olein, such as in a total combined amount of 0.01 to 0.08 wt % based on the palm olein, such as in a total combined amount of 0.01 to 0.07 wt % based on the palm olein, such as in a total combined amount of 0.01 to 0.06 wt % based on the palm olein, such as in a total combined amount of 0.01 to 0.05 wt % based on the palm olein, such as in a total combined amount of 0.015 to 0.05 wt % based on the palm olein, such as in a total combined amount of 0.02 to 0.05 wt % based on the palm olein.

In one aspect the STS has an acid value of no greater than 10. In a further aspect, the STS has an acid value of no greater than 8. In a further aspect, the STS has an acid value of no greater than 7. In a further aspect, the STS has an acid value of no greater than 5, In a further aspect, the STS has an acid value of no greater than 4 In a further aspect, the STS has an acid value of no greater than 3, In a further aspect, the STS has an acid value of no greater than 2.

If STS is present, the STS and Ester/Salt may be dosed into the palm olein either sequentially or together, If they are dosed sequentially, either the STS or the Ester/Salt so may be added first. The STS and Ester/Salt may be blended together for dosing as a single material, For example, the STS and Ester/Salt may be co-crystallised and, optionally then spray crystallised to form a powder, such that a single material of a given ratio of STS to Ester/Salt is provided.

We have now surprisingly found that the esters described herein, such as SSL, may enhance the effect of PGE, which is a known prior. art anticrystalliser. In one preferred aspect, and as discussed herein, the palm olein composition further comprises a polyglycerol ester. The present inventors have further found that (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof, may be combined with a polyglycerol ester as a crystallisation inhibitor. Thus not only does the present lactic acid ester or fumaric acid ester act a crystallisation inhibitor itself, but it may also be combined with a known polyglycerol ester to provide a beneficial effect. In this aspect the present invention provides
a palm olein composition comprising:
   (a) palm olein oil;
   (b) (i) a lactic acid ester selected from an ester of lactic acid and a C12 to C22 fatty acid, salts thereof and mixtures thereof; or
      (ii) a fumaric acid ester selected from an ester of fumaric acid and a C12 to C22 fatty alcohol, salts thereof and mixtures thereof.
   (c) a polyglycerol ester.
a process for inhibiting crystallisation of triglyceride in palm olein oil, the process comprising the step of combining (a) (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof, and (b) a polyglycerol ester with the palm olein oil.
use of (a) (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof. and (b) a polyglycerol ester for inhibiting crystallisation of triglyceride in palm olein oil.

If present, the polyglycerolester should of course be present in any suitable amount to provide the desired effect, such as improved crystallisation inhibition. This amount may be readily determined by one skilled in the art.

The palm olein composition may contain both STS described herein and a polyglycerol ester as described herein, Namely, there is provided a palm olein composition comprising: (a) palm olein oil; (b) (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof, (c) a polyglycerol ester, and (d) STS.

When the present palm olein composition contains solely palm olein oil and ester/salt, then it will be appreciated that these components may be combined together in any suitable manner. When further components are present it is envisaged that the components may be combined in any suitable order or simultaneously. For example, then STS is present the ester/salt may be combined with the oil and the STS added, the STS may be combined with the oil and the ester/salt added, or the STS and ester/salt combined and then contacted with the oil. In the latter aspect, the ester/salt may be dissolved in liquid STS or the ester/salt may be dry mixed with STS.

Process

In one aspect the present invention provides a process for inhibiting crystallisation of triglyceride in palm olein oil, the process comprising the step of combining with the palm olein oil, (i) a lactic acid ester selected from an ester of lactic acid and a C12 to C22 fatty acid, salts thereof and mixtures thereof; or (ii) a fumaric acid ester selected from an ester of fumaric acid and a C12 to C22 fatty alcohol, salts thereof and mixtures thereof.

It will be appreciated that ‘combining’ as discussed herein may be by any suitable means. For example the components may be mixed, melted, dissolved or combinations thereof.

The process should provide inhibition of crystallisation across a range of temperatures at which the palm olein composition is likely to be stored during acceptable handling. In a preferred aspect, the crystallisation of triglyceride in the palm olein composition is inhibited during storage of the palm olein composition at a temperature of less than 25° C., preferably the crystallisation of triglyceride in palm olein composition is inhibited during storage of the palm olein composition at a temperature of less than 20° C., preferably the crystallisation of triglyceride in palm olein composition is inhibited during storage of the palm olein composition at a temperature of less than 18° C., preferably the crystallisation of triglyceride in palm olein composition is inhibited during storage of the palm olein oil at a temperature of less than 15° C., preferably the crystallisation of triglyceride in palm olein composition is inhibited during storage of the palm olein composition at a temperature of less than 12° C., preferably the crystallisation of triglyceride in palm olein composition is inhibited during storage of the palm olein composition at a temperature of less than 10° C., preferably the crystallisation of triglyceride in palm olein composition is inhibited during storage of the palm olein composition at a temperature of less than 5° C., preferably the crystallisation of triglyceride in palm olein composition is inhibited during storage of the palm olein composition at a temperature of at least 0° C.

In a preferred aspect, the crystallisation of triglyceride in the palm olein composition is inhibited during storage of the palm olein composition at a temperature of approximately 25° C., preferably the crystallisation of triglyceride in palm olein composition is inhibited during storage of the palm olein composition at a temperature of from 25° C. to 20° C., preferably the crystallisation of triglyceride in palm olein composition is inhibited during storage of the palm olein composition at a temperature of from 25° C. to 18° C., preferably the crystallisation of triglyceride in palm olein composition is inhibited during storage of the palm olein oil at a temperature of from 25° C. to 15° C., preferably the crystallisation of triglyceride in palm olein composition is inhibited during storage of the palm olein composition at a temperature of from 25° C. to 12° C., preferably the crystallisation of triglyceride in palm olein composition is inhibited during storage of the palm olein composition at a temperature of from 25° C. to 10° C., preferably the crystallisation of triglyceride in palm olein composition is inhibited during storage of the palm olein composition at a temperature of from 25° C. to 5° C., preferably the crystallisation of triglyceride in palm olein composition is inhibited during storage of the palm olein composition at a temperature of from 25° C. to 0° C.

It is a requirement that the present invention inhibits crystallisation of triglyceride in the palm olein oil, This inhibition may be any mechanism, Without being bound by theory it is understood that the lactic acid ester or fumaric acid ester described herein inhibits nucleation of the triglyceride such that its crystallisation is inhibited,

It will be understood by one skilled in the art that the process steps described herein are not exhaustive and that the invention may be practiced by addition of one or more steps either before the steps recited herein, after the steps recited herein, intermediate to the steps recited herein, and combinations thereof.

Further Aspects

In one further aspect the present invention provides a palm olein composition comprising: (a) palm olein oil (b) an ester of (i) lactic acid or fumaric acid and (ii) a C12 to C22 fatty acid, or a salt thereof. In one further aspect the present invention provides a palm olein composition comprising: (a) palm olein oil (b) an ester of (i) lactic acid and (ii) a C12 to C22 fatty acid, or a salt thereof.

In one further aspect the present invention provides a process for inhibiting crystallisation of triglyceride in palm olein oil, the process comprising the step of combining with the palm olein oil, an ester of (i) lactic acid or fumaric acid and (ii) a C12 to C22 fatty acid or a salt thereof. In one further aspect the present invention provides a process for inhibiting crystallisation of triglyceride in palm olein oil, the process comprising the step of combining with the palm olein oil, an ester of (i) lactic acid and (ii) a C12 to C22 fatty acid or a salt thereof.

In one further aspect the present invention provides use of an ester of (i) lactic acid or fumaric acid and (ii) a C12 to C22 fatty acid or a salt thereof for inhibiting crystallisation of triglyceride in palm olein oil. In one further aspect the present invention provides use of an ester of (i) lactic acid and (ii) a C12 to C22 fatty acid or a salt thereof for inhibiting crystallisation of triglyceride in palm olein oil.

The present invention will now be described in further detail by way of example on with reference to the accompanying figures in which:

FIG. 1 shows a scheme, and

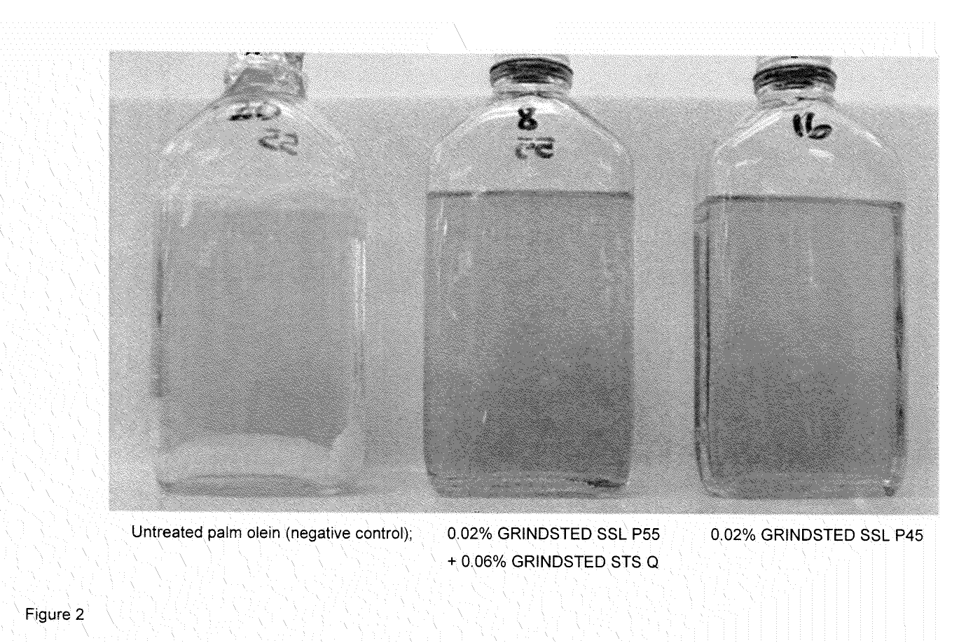

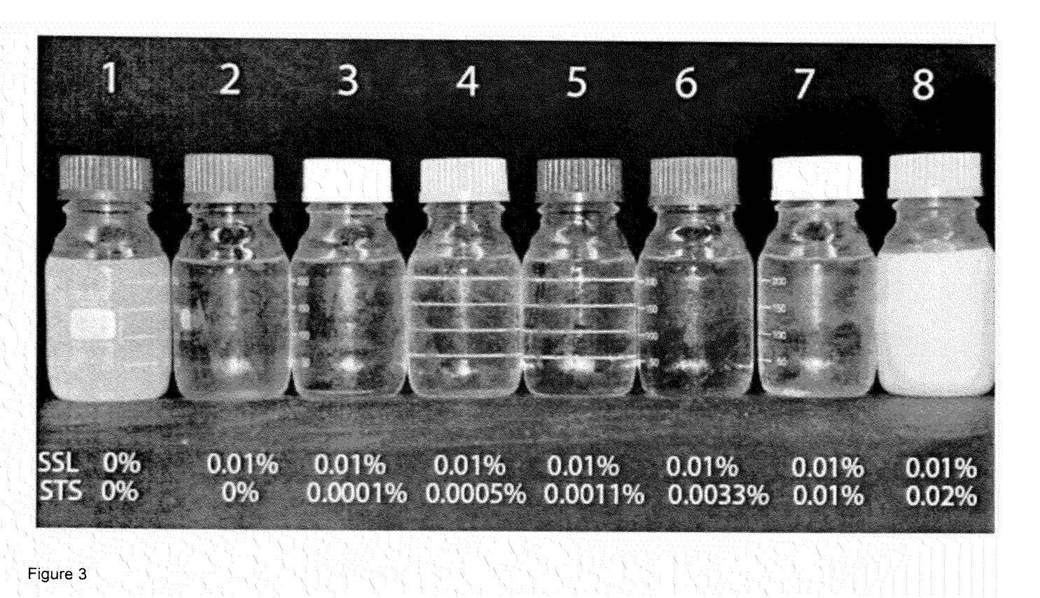

FIGS. 2 and 3 show samples.

The present invention will now be described in further detail in the following examples.

### EXAMPLES

### Example 1

In the following example sodium stearoyl-2-lactylate (GRINDSTED SSL P45 and GRINDSTED SSL P55) was incorporated into double fractionated 60IV palm olein cooking oils, both alone and in combination with sorbitan tristearate (GRINDSTED STS Q).

GRINDSTED SSL P45, GRINDSTED SSL P55 and GRINDSTED STS Q are each available from DuPont (formerly Danisco A/S).

Samples of cooking oil were made as below:
i. a 1% w/w solution of SSL was made up in 60IV palm olein, and held warm (60° C.) until required.
ii to each test beaker, add the required amount of SSL solution and sufficient 60IV palm olein to enable final net beaker weight of 170g.
iii. place each beaker on a stirrer/hotplate, add required STS and heat to 65° C. with agitation: ensure all SSL and STS is dissolved.
iv. add 145 g of each solution to a sample bottle, retaining the balance for turbidity measurement.
v. transfer sample bottles to 65° C. water bath and hold 2 hours.
vi. place samples on bench (22° C.) for 90 minutes.
vii. transfer samples to 18° C. water bath and monitor visually on a daily basis. The observer monitored for signs of crystallisation.

Negative controls consisted of pure 60IV palm olein.

Positive controls contained either 0.04, 0.06 or 0.08% w/w GRINDSTED STS Q.

SSL was tested in the range 0.02-0.1% w/w either on its own, Or in combination with one of 0.04, 0.06 or 0.08% GRINDSTED STS Q.

The amounts introduced into each of the sample bottles is given in the table below.

| | | | 1% P55 in |
|---|---|---|---|
| Bottle # | Sample | STS Q g/170 g total | Pol (g) |
| 1 | 0.04 STS Q | 0.068 | 0 |
| 2 | 0.06 STS Q | 0.102 | 0 |
| 3 | 0.08 STS Q | 0.136 | 0 |
| 4 | 0.02P55 + 0.04 STS Q | 0.068 | 3.4 |
| 5 | 0.04P55 + 0.04 STS Q | 0.068 | 6.8 |
| 6 | 0.08P55 + 0.04 STS Q | 0.068 | 13.6 |
| 7 | 0.1P55 + 0.04 STS Q | 0.068 | 17 |
| 8 | 0.02P55 + 0.06 STS Q | 0.102 | 3.4 |
| 9 | 0.04P55 + 0.06 STS Q | 0.102 | 6.8 |
| 10 | 0.08P55 + 0.06 STS Q | 0.102 | 13.6 |
| 11 | 0.1P55 + 0.06 STS Q | 0.102 | 17 |
| 12 | 0.02P55 + 0.08 STS Q | 0.136 | 3.4 |
| 13 | 0.04P55 + 0.08 STS Q | 0.136 | 6.8 |
| 14 | 0.08P55 + 0.08 STS Q | 0.136 | 13.6 |
| 15 | 0.1P55 + 0.08 STS Q | 0.136 | 17 |
| 16 | 0.02% P55 | 0 | 3.4 |
| 17 | 0.04% P55 | 0 | 6.8 |
| 18 | 0.08% P55 | 0 | 13.6 |
| 19 | 0.10% P55 | 0 | 17 |
| 20 | CONTROL 60IV | 0 | 0 |

Samples of 0.02% SSL by itself, and with SSL+STS were found to resist crystallisation onset in a superior fashion to untreated palm olein.

FIG. 2: cooking oil samples at 107 days.

From left to right:

untreated palm olein (negative control);

0.02% GRINDSTED SSL P55+0.06% GRINDSTED STS Q;

0.02% GRINDSTED SSL P45.

Only the untreated olein shows crystallisation (see for example, bottom ⅛th of bottle).

### Example 2

In the following example sodium stearoyl-2-lactylate (GRINDSTED SSL P45, GRINDSTED SSL P55, and GRINDSTED SSL P86) both alone and in combination with sorbitan tristearate (GRINDSTED STS Q), was incorporated into (refined bleached deodorised) fractionated 60IV palm olein cooking oils and into blends of 60IV palm olein cooking oil and rape seed oil.

Samples of cooking oil were made as below:
1. Heat the oil or oil blend to 60° C. for 30 min and mix. Allow to cool to ambient temperature.
2. Weigh off the anticrystalliser and the oil phase.
3. Place the samples at 90° C. for 3 h and mix.
4. Cool the samples to ambient temperature.
5. Place the samples at the test temperatures.

* denotes that the sample showed turbidity prior to crystallisation being observed.

SSL P55 and STS Q

| | 18° C. | | | | | | |
|---|---|---|---|---|---|---|---|
| | STS Q | Palm olein Cp 5° C. | | | | | |
| SSL P55 | 0% | 0.02% | 0.04% | 0.06% | 0.08% | 0.10% | 0.12% |
| 0% | 9 | 12 | 28 | 28 | 12 | 30 | 33 |
| 0.0050% | 13 | 98 | 103 | 98 | 99 | 131 | 103 |
| 0.0100% | 20 | 113 | 110 | 72 | 91 | 119* | 132* |
| 0.0150% | 32 | 124 | 132 | 125* | 142* | 121* | 161* |
| 0.0200% | 106 | 118 | 119 | 97* | 105 | 105* | 143* |

| | 15° C. | | | | | |
|---|---|---|---|---|---|---|
| | STS Q | Palm olein Cp 5° C. | | | | |
| SSL P55 | 0% | 0.02% | 0.04% | 0.06% | 0.08% | 0.10% |
| 0% | 4 | 4 | 10 | 10 | 10 | 16* |
| 0.0020% | 4 | 7 | 15 | 13 | 17 | 20* |
| 0.0050% | 4 | 16 | 19 | 20* | 20* | 17* |
| 0.0100% | 9 | 17 | 20 | 21* | 23* | 18* |

| | 12° C. | | | | | |
|---|---|---|---|---|---|---|
| | STS Q | 50:50 Blend (palm olein Cp 5° C.:rape seed oil) | | | | |
| SSL P55 | 0% | 0.02% | 0.04% | 0.06% | 0.08% | 0.10% |
| 0% | 7 | 11 | 13 | 13 | 10 | 13 |
| 0.0020% | 6 | 24 | 23 | 19 | 13 | 19 |
| 0.0050% | 7 | 32 | 29 | 29 | 24* | 23* |
| 0.0100% | 21 | 44 | 35 | 29 | 38* | 31* |
| 0.0150% | n/a | 33* | 26* | 31* | 38* | 38* |

SSL P45 and STS Q

| | 18° C. | | | | | | |
|---|---|---|---|---|---|---|---|
| | STS Q | Palm olein Cp 5° C. | | | | | |
| SSL P45 | 0% | 0.02% | 0.04% | 0.06% | 0.08% | 0.10% | 0.12% |
| 0% | 14 | 34 | 38 | 49 | 64 | 112 | 112 |
| 0.0050% | 17 | 92 | 134 | >167 | 118 | 117 | >167 |
| 0.0100% | 27 | 140 | >167 | >167 | >167 | 56* | 70* |
| 0.0150% | 77 | 132* | 131* | >167* | 58* | 138* | >167* |
| 0.0200% | 65* | 137* | >167* | >167* | >167* | >167* | >167* |

| | 15° C. | | | | | | |
|---|---|---|---|---|---|---|---|
| | STS Q | Palm olein Cp 5° C. | | | | | |
| SSL P45 | 0% | 0.02% | 0.04% | 0.06% | 0.08% | 0.10% | 0.12% |
| 0% | 5 | 8 | 11 | 17 | 13* | 13* | 13* |
| 0.0050% | 8 | 20 | 29 | 31 | 42* | 38* | 32* |
| 0.0100% | 11 | 41* | 36* | 45* | 37* | 66* | 32* |
| 0.0150% | 14 | 38* | 56* | 45* | 45* | 44* | 52* |
| 0.02% | 34* | 35* | 34* | 42* | 39* | 43* | 39* |

| | 12° C. | | | | | |
|---|---|---|---|---|---|---|
| | STS Q | 50:50 Blend (palm olein Cp 5° C. (080212-01):rape seed oil) | | | | |
| SSL P45 | 0% | 0.02% | 0.04% | 0.06% | 0.08% | 0.10% |
| 0% | 5 | 9* | 19* | 23* | 19* | 19* |
| 0.0020% | 5* | 14* | 14* | 13* | 23* | 21* |
| 0.0050% | 6 | 32 | 21 | 23 | 22* | 21* |
| 0.0100% | 10 | 22 | 41* | 35* | 41* | 12* |
| 0.0150% | 22* | 25* | 30* | 26* | 34* | 38* |

SSL P86 and STS Q

| | 15° C. | | | | | | |
|---|---|---|---|---|---|---|---|
| | STS Q | Palm olein Cp 5° C. | | | | | |
| SSL P86 | 0% | 0.02% | 0.04% | 0.06% | 0.08% | 0.10% | 0.12% |
| 0% | 4 | 4 | 6 | 8 | 12* | 12* | 12* |
| 0.0050% | 4 | 9 | 15 | 21 | 28 | 29* | 15 |
| 0.0100% | 4 | 20 | 19 | 28 | 27 | 29* | 30* |
| 0.0150% | 6 | 14 | 32 | 32 | 19 | 28* | 27* |
| 0.02% | 7 | 16 | 17 | 17 | 20 | 18* | 18* |

| | 18° C. | | | | | | |
|---|---|---|---|---|---|---|---|
| | STS Q | Palm olein Cp 5° C. | | | | | |
| SSL P86 | 0% | 0.02% | 0.04% | 0.06% | 0.08% | 0.10% | 0.12% |
| 0% | 5 | 7 | 11 | 13 | 19 | 27* | 21* |
| 0.0050% | 5 | 12 | 26 | 57 | 39 | >112 | 42 |
| 0.0100% | 7 | >112 | 92 | 74 | >112 | >112 | >112 |
| 0.0150% | 15 | 53 | 104 | >112 | >112 | 53 | >112 |
| 0.0200% | 21 | 57 | 108 | 75 | >112 | 91 | 57 |

| | 12° C. | | | | | |
|---|---|---|---|---|---|---|
| | STS Q | 50:50 Blend (palm olein Cp 5° C.:rape seed oil) | | | | |
| SSL P86 | 0% | 0.02% | 0.04% | 0.06% | 0.08% | 0.10% |
| 0% | 5 | 9 | 9 | 21* | 17* | 8* |
| 0.0020% | 5 | 16 | 19 | 14 | 12* | 23* |
| 0.0050% | 7 | 33 | 36 | 20 | 17 | 13* |
| 0.0100% | 12 | 21* | 20* | 30* | 30* | 13* |
| 0.015% | 24* | 27* | 33* | 30* | 30* | 50* |

### Example 3

In the following example potassium stearoyl-2-lactylate PSL) both alone and in combination with sorbitan tristearate (GRINDSTED STS Q), was incorporated into fractionated 60IV palm olein cooking oil and into a 50:50 blend of 60IV palm olein cooking and rape seed oil.

The samples of cooking oil were made in accordance with Example 2.

* denotes that the sample showed turbidity prior to crystallisation being observed.

| | 12° C. | | | | | |
|---|---|---|---|---|---|---|
| | STS Q | 50:50 Blend (Palm olein Cp 5° C.:rape seed oil) | | | | |
| PSL | 0% | 0.02% | 0.04% | 0.06% | 0.08% | 0.10% |
| 0% | 7 | 12 | 21* | 21* | 20* | 20* |
| 0.0020% | 10 | 26 | 27 | 25 | 20* | 19* |
| 0.0050% | 19 | 70* | 71* | 40* | 40* | 61* |
| 0.0100% | 103* | >160* | 125* | 74* | 62* | 61* |

| | 15° C. | | | | | |
|---|---|---|---|---|---|---|
| | STS Q | Palm olein Cp 5° C. | | | | |
| PSL | 0% | 0.02% | 0.04% | 0.06% | 0.08% | 0.10% |
| 0% | 4 | 5 | 6 | 6 | 7 | 7 |
| 0.0020% | 4 | 7 | 9 | 9 | 10 | 10* |
| 0.0050% | 4 | 7 | 10 | 10 | 26* | 12* |
| 0.0100% | 4 | 7 | 18* | 10* | 10* | 5 |

### Example 4

In the following example sodium oleyl-2-lactylate (SOL) was prepared from approx 34% lactic acid and based on Palmac 760 (min 75% oleic acid). The sample is denoted SOL, The SOL was tested both alone and in combination with sorbitan tristearate (GRINDSTED STS Q) in a 50:50 blend Of 60IV palm olein cooking oil and rape seed oil,

The samples of cooking oil were made in accordance with Example 2.

* denotes that the sample showed turbidity prior to crystallisation being observed.

| | 12° C. | | | | | |
|---|---|---|---|---|---|---|
| | STS Q | 50:50 Blend (palm olein Cp 5° C. (080212-01):rape seed oil) | | | | |
| SOL | 0% | 0.02% | 0.04% | 0.06% | 0.08% | 0.10% |
| 0% | 4 | 8 | 15 | 11* | 10* | 10* |
| 0.0020% | 4 | 8 | 12 | 11* | 24* | 21* |
| 0.0050% | 5 | 15 | 26 | 18 | 12* | 28* |
| 0.0100% | 6 | 27 | 24 | 25 | 45 | 14 |
| 0.0150% | 6 | 27 | 46 | 26 | 54* | 43* |
| 0.0200% | 6 | 31 | 41 | 45 | 49* | 49* |
| 0.0250% | 6 | 34 | 54 | 54 | 50 | 48 |

### Example 5

Samples of cooking oil were made as below:
1. prepare a 2% concentrate of the anticrystallizer by dispersing in the oil blend and heating until a clear, homogeneous solution is obtained (heat to 75° C. and hold 10 minutes). Typically, depending on the number of samples to be put on, this comprises either dissolving 1g of anticrystalliser in 49 g of oil blend, or 2 g of anticrystalliser in 98 g of oil blend
2. dose this concentrate at the required level into the required aliquot of the oil blend which has been tempered to 30° C. and mix for 20 minutes, holding the mixture at 30° C.
3. Typically this is to produce a 200 g total. A 400 g tall form beaker is used to hold this mixture, and it is agitated with an overhead stirrer fitted with a propeller type impeller.
4. Transfer 150 g to a test bottle, and fix the cap. transfer to storage temperature (12° C. for the work reported herein) and monitor at regular intervals, ideally daily, for signs of instability. Failure is any significant loss of
6. clarity, crystallisation, appearance of sediment or formation of flocculant or curtain like structures within the oil.
7. report result as days to failure.

In the following example sodium stearoyl-2-lactylate (SSL), sodium palmitoyl lactylate (SPL) and potassium stearoyl-2-lactylate (PSL), each alone and in combination with sorbitan tristearate (GRINDSTED STS Q), was incorporated into an oil which was 50:50 blend of canola oil and a palm olein having a diglyceride content of 9.2%. The samples were tested at 12° C.

| | | | | | | g 1% | g 1% | | |
|---|---|---|---|---|---|---|---|---|---|
| | | % | | | | STS Q/ | SPL/ | | |
| Bottle | Anti | STS | % | % | % | 200 g | 200 g | Failure | |
| # | Cryst. | Q | SSL | PSL | SPL | total | total | days | How failed |
| 1 | | 0 | | | 0 | | | 3 | crystallisation |
| 2 | STS | 0.02 | | | 0 | 4 | | 4 | turbid |
| 3 | STS | 0.04 | | | 0 | 8 | | 4 | turbid |
| 4 | STS | 0.06 | | | 0 | 12 | | 4 | floc |
| 5 | STS | 0.08 | | | 0 | 16 | | 3 | floc |
| 6 | STS | 0.1 | | | 0 | 20 | | 3 | floc |
| 7 | SPL | 0 | | | 0.005 | | 1 | 3 | crystallisation |
| 8 | SPL | 0 | | | 0.01 | | 2 | 3 | crystallisation |
| 9 | SPL | 0 | | | 0.015 | | 3 | 3 | crystallisation |
| 10 | SPL | 0 | | | 0.02 | | 4 | 4 | dusting |
| 11 | SPL/STS | 0.02 | | | 0.005 | 4 | 1 | 4 | turbid |
| 12 | SPL/STS | 0.02 | | | 0.01 | 4 | 2 | 10 | turbid |
| 13 | SPL/STS | 0.02 | | | 0.015 | 4 | 3 | 31 | crystallisation |
| 14 | SPL/STS | 0.02 | | | 0.02 | 4 | 4 | 40 | dusting |
| 15 | SPL/STS | 0.04 | | | 0.005 | 8 | 1 | 4 | turbid |
| 16 | SPL/STS | 0.04 | | | 0.01 | 8 | 2 | 6 | turbid |
| 17 | SPL/STS | 0.04 | | | 0.015 | 8 | 3 | 20 | crystallisation |
| 18 | SPL/STS | 0.04 | | | 0.02 | 8 | 4 | 32 | dusting |
| 19 | PSL/STS | 0.02 | | 0.01 | | 3 | | 21 | crystallisation |
| 20 | PSL/STS | 0.03 | | 0.015 | | 4.5 | | 40 | Dusting |
| 21 | PSL/STS | 0.04 | | 0.02 | | 6 | | 20 | Cloudy |
| 22 | PSL/STS | 0.05 | | 0.025 | | 7.5 | | 40 | Sl. Turbid |
| 23 | P55/STS | 0.02 | 0.01 | | | 3 | | 10 | turbid |
| 24 | P55/STS | 0.03 | 0.015 | | | 4.5 | | 10 | crystallisation |
| 25 | P55/STS | 0.04 | 0.02 | | | 6 | | 31 | Dusting |
| 26 | P55/STS | 0.05 | 0.025 | | | 7.5 | | 39 | Dusting |
| 27 | SPL/STS | 0.02 | | | 0.01 | | | 10 | crystallisation |
| 28 | SPL/STS | 0.03 | | | 0.015 | | | 17 | Dusting |
| 29 | SPL/STS | 0.04 | | | 0.02 | | | 40 | Dusting |
| 30 | SPL/STS | 0.05 | | | 0.025 | | | 40 | Dusting |

Bottles 19-22 contain a co-crystallised blend of 2 parts STS Q. 1 part PSL.

Bottles 23-26 contain the co-crystallised blend of 2 parts STS Q: 1 part SSL P55.

Bottles 27-30 contain varying amounts as specified of STS Q and SPL in the ratio 2:1, added as singles.

### Example 6

In the following example sodium stearoyl-2-lactylate (SSL) as used in combination with sorbitan tristearate (GRINDSTED STS Q), was incorporated into an oil which was 50:50 blend of canola oil and a palm olein having a diglyceride content of 9.2%. The samples were tested at 12° C. Samples of STS alone were also tested.

Blend 019 is a blend of 33wt % SSL P55 and 67wt % STS Q. The sample is prepared by co-crystallisation.

The samples of cooking oil were made in accordance with Example 5 except that the oil was heated to 70° C. in step 1.

5R, 6R and 7R are replicates of 5, 6 and 7 but made up with a palm olein having a diglyceride content of approximately 7.5%.

| | | | | Blend | Average | |
|---|---|---|---|---|---|---|
| | Oil Blend | | | (g 2% | Failure | |
| | (% Canola/ | 019 | | solution/ | days | |
| Bottle | % 60IV | Blend | ST S % | 170 g | (duplicate | |
| # | olein) | (% w/w) | w/w) | bottle)* | runs) | How failed |
| 1 | 50/50 | 0 | | | 1 | flocculation |
| 2 | 50/50 | 0.03 | | 2.55 | 13 | dusting |
| 3 | 50/50 | 0.045 | | 3.825 | 17 | dusting |
| 4 | 50/50 | 0 | 0.06 | 0.102 | 7 | flocculation |
| 5 | 60/40 | 0 | | | 2 | flocculation |
| 6 | 60/40 | 0.03 | | 2.55 | 46 | |
| 7 | 60/40 | 0.045 | | 3.825 | 35 | dusting |
| 8 | 60/40 | 0 | 0.06 | 0.102 | 17 | flocculation |
| 5R | 60/40 | 0 | | | 17 | nucleation |
| 6R | 60/40 | 0.03 | | 2.55 | 30 | slight |
| | | | | | | turbidity |
| 7R | 60/40 | 0.045 | | 3.825 | 31 | slight |
| | | | | | | turbidity |
| 9 | 70/30 | 0 | | | 4 | dusting |
| 10 | 70/30 | 0.03 | | 2.55 | 7 | flocculation |
| 11 | 70/30 | 0.045 | | 3.825 | 41 | nucleation |
| 12 | 70/30 | 0 | 0.06 | 0.102 | 11 | flocculation |
| 13 | 80/20 | 0 | | | 17 | haze |
| 14 | 80/20 | 0.03 | | 2.55 | 7 | flocculation |
| 15 | 80/20 | 0.045 | | 3.825 | 22 | flocculation |
| 16 | 80/20 | 0 | 0.06 | 0.102 | 9 | flocculation |

### Example 7

In the following example calcium stearoyl-2-lactylate (CSL) was used alone and in combination with sorbitan tristearate (GRINDSTED STS Q), was incorporated into an oil which was 50:50 blend of canola oil and a palm olein having a diglyceride content of 9.2%. The samples were tested at 12° C.

The samples of cooking oil were made in accordance with Example 5.

| | | | | g 1% | g 1% | | |
|---|---|---|---|---|---|---|---|
| | | | | STSQ/ | CSL/ | | |
| Bottle | Anti- | % ST | % | 200 g | 200 g | Failure | How |
| # | Cryst | SQ | CSL | total | total | days | failed |
| 1 | | 0 | 0 | | | <3 | Turbid |
| 2 | STS | 0.02 | 0 | 4 | | <3 | Turbid |
| 3 | STS | 0.04 | 0 | 8 | | <3 | Turbid |
| 4 | STS | 0.06 | 0 | 12 | | <3 | Turbid |
| 5 | STS | 0.08 | 0 | 16 | | <3 | Turbid |
| 6 | STS | 0.1 | 0 | 20 | | <3 | Turbid |
| 7 | CSL | 0 | 0.005 | | 1 | <3 | Crystallisation |
| 8 | CSL | 0 | 0.01 | | 2 | <3 | Crystallisation |
| 9 | CSL | 0 | 0.015 | | 3 | <3 | Crystallisation |
| 10 | CSL | 0 | 0.02 | | 4 | <3 | Crystallisation |
| 11 | CSL/STS | 0.02 | 0.005 | 4 | 1 | <3 | Turbid |
| 12 | CSL/STS | 0.02 | 0.01 | 4 | 2 | <3 | Turbid |
| 13 | CSL/STS | 0.02 | 0.015 | 4 | 3 | <3 | Turbid |
| 14 | CSL/STS | 0.02 | 0.02 | 4 | 4 | <3 | Turbid |
| 15 | CSL/STS | 0.04 | 0.005 | 8 | 1 | <3 | Turbid |
| 16 | CSL/STS | 0.04 | 0.01 | 8 | 2 | <3 | Turbid |
| 17 | CSL/STS | 0.04 | 0.015 | 8 | 3 | <3 | Turbid |
| 18 | CSL/STS | 0.04 | 0.02 | 8 | 4 | <3 | Turbid |
| 19 | CSL/STS | 0.02 | 0.010 | 4 | 2 | <3 | Turbid |
| 20 | CSL/STS | 0.03 | 0.015 | 6 | 3 | 5 | Cloudy |
| 21 | CSL/STS | 0.04 | 0.020 | 8 | 4 | <3 | Turbid |
| 22 | CSL/STS | 0.05 | 0.025 | 10 | 5 | <3 | Turbid |

### Example 8

In the following example sodium stearoyl-2-lactylate (SSL) was used alone and was incorporated into an oil which was a 30:70 blend of palm olein cooking oil (CP 5° C.) and rape seed oil. The mix was subjected to a very stringent test of being cooled to 0° C.,

Procedure
1, Heat oil blend with emulsifiers to 130° C. (cabinet 200° C.),
2. Filter (Whatmann 115).
3. Fill 225 g in suitable blue cap bottle.
4. Cool to 25° C. in water bath.
5. Place samples in ice water and inspect for turbidity and crystallisation for 5.5 h.

| | | 0.005% | 0.010% |
|---|---|---|---|
| Time h | Ref | SSL P 55 | SSL P 55 |
| 0.5 | Clear | Clear | clear |
| 1 | slightly turbid | Clear | clear |
| 1.5 | | Clear | clear |
| 2 | slightly turbid | slightly turbid | clear |
| 2.5 | | Turbid | clear |
| 3 | Turbid | very turbid | clear |
| 4 | very turbid | very turbid | clear |
| 4.5 | | very turbid | clear |
| 5 | | very very turbid | clear |
| 5.5 | starts to solidify | very very turbid | clear |

### Example 9

In the following example sodium stearoyl-2-lactylate (SSL P55) was used in combination with sorbitan tristearate (GRINDSTED STS Q) and was incorporated into an oil which was 40:60 blend of palm olein have a cloud point of 5° C. and rape seed oil. The mix was subjected to the very stringent procedure of Example 8, being cooled to 0° C.

The data are given below and the samples are shown in FIG. 3. As can be seen in FIG. 3, the difference between samples 2 to 7 is small, but sample 5 is the best. The hazy appearance on bottles 2-7 is due to water condensation.

Oil blend 30:70 - palm olein CP 5° C.:rape seed oil

| | 1 | 2 | 3 | 4 | 5 | 6 | 7 | 8 |
|---|---|---|---|---|---|---|---|---|
| SSL P55% | 0 | 0.01 | 0.01 | 0.01 | 0.01 | 0.01 | 0.01 | 0.01 |
| STS Q % | 0 | 0 | 0.0001 | 0.0005 | 0.0011 | 0.0033 | 0.001 | 0.002 |
| Time (h) | | | | | | | | |
| 0.5 | Clear | Clear | Clear | Clear | Clear | Clear | Clear | Clear |
| 1 | Clear | Clear | Clear | Clear | Clear | Clear | Clear | Turbid |
| 1.5 | Clear | Clear | Clear | Clear | Clear | Clear | Clear | Very turbid |
| 2 | Slightly | Clear | Clear | Clear | Clear | Clear | Clear | Very turbid |
| | turbid | | | | | | | |
| 2.5 | Turbid | Clear | Clear | Clear | Clear | Clear | Clear | Very, very |
| | | | | | | | | turbid |
| 3 | Very turbid | Clear, but | Clear | Clear, but | Clear | Clear | Clear | Very, very |
| | | clouds | | clouds | | | | turbid |
| | | locally | | locally | | | | |
| 3.5 | Very turbid | Clear, but | Clear, but | Clear, but | Clear | Clear | Clear | Very, very |
| | | clouds | clouds | clouds | | | | turbid |
| | | locally | locally | locally | | | | |
| 4 | Very turbid | Clear, but | Clear, but | Clear, but | Clear | Clear, but | Clear, but | Pasty |
| | | clouds | clouds | clouds | | some crystals | some crystals | |
| | | locally | locally | locally | | in upper half | in upper half | |
| 4.5 | Very turbid | Clear, but | Clear, but | Clear, but | Clear, but | Clear, but | Slightly | Nearly |
| | | clouds | clouds | clouds | few crystals | some crystals | turbid with | solid |
| | | locally | locally | locally | in top | in upper half | crystals | |
| 5 | Very turbid | Clear, but | Clear, but | Clear, but | Clear, but | Clear, but | Slightly | Solid |
| | | clouds | clouds | clouds | few crystals | some crystals | turbid with | |
| | | locally | locally | locally | in top | in upper half | crystals | |
| 5.5 | Very turbid | Clear, but | Clear, but | Clear, but | Clear, but | Clear, but | A good deal | Solid |
| | | clouds | clouds | clouds | few crystals | some crystals | of crystals | |
| | | locally | locally | locally | in top | in upper half | | |

Oil mix - 40% Palm olein CP 5° C. and 60% Rape seed oil

| | | 0.005% | 0.001% |
|---|---|---|---|
| Time (h) | Reference | SSL P55 | SSL P55 |
| 0.5 | Clear | Clear | Clear |
| 1 | Very turbid | Very turbid | Very, very |
| | | | turbid |
| 2 | Very, very | Very, very | Very, very |
| | turbid | turbid | turbid |
| 3 | Nearly | Nearly | Nearly |
| | solid | solid | solid |
| 4 | Solid | Solid | Solid |
| 5.5 | Solid | Solid | Solid |

### Example 10

In the following example sodium stearyl fumarate (SSF) (available from A&Z Food Additives Co. Ltd, China and having a purity >99%) was used in combination with sorbitan tristearate (GRINDSTED STS Q) and was incorporated into an oil which was 50:50 blend of palm olein having a cloud point of 5° C. and rape seed oil. The samples were tested at 12° C.

Procedure:

After weighing out the emulsifiers and oil blends the mixes were heated together to 90° C. for 3 hours in closed blue cap bottles followed by gentle shaking of the bottles. The samples were allowed to cool to ambient temperature and subsequently stored at the test temperature. The samples were inspected daily for appearance and crystallisation.

| | STS Q | | |
|---|---|---|---|
| SSF | 0% | 0.02% | 0.04% |
| 0% | 4 | 6 | 13 |
| 0.0020% | 4* | 7* | 15* |
| 0.0050% | 4* | 6* | 14* |
| 0.0100% | 4* | 13* | 20* |
| 0.0200% | 4* | 9* | 14* |

*all samples with SSF did not dissolve completely during sample preparation.

The un-dissolved SSF formed a thin dusty layer at the bottom during storage

A synergistic anticrystalliser effect is seen at 0.01% SSF+0.04% STS Q as compared to addition of STS Q alone. SSF has very low solubility in oil, which causes the initial precipitation.

### Example 11

In the following example potassium stearoyl lactylate (PSL) was used in combination with sorbitan tristearate (GRINDSTED STS Q) and was incorporated into an oil which was 50:50 blend of palm olein have a cloud point of 5° C. and rape seed oil. The samples were tested at 12° C. and 15° C.

Procedure:

The samples were prepared in the same manner as Example 10.

| | STS Q | | | | |
|---|---|---|---|---|---|
| PSL 2671/051 | 0% | 0.02% | 0.04% | 0.06% | 0.08% |
| 0% | 7 | 12 | 7 | 7 | 7 |
| 0.0020% | 10 | 26 | 27 | 25 | 4 |
| 0.0050% | 19 | 21 | 21 | 4 | 4 |
| 0.0100% | 4 | 4 | 4 | 4 | 4 |

PSL at 12° C. shows effect as anticrystalliser in cooking oil in combination with STS and as single ingredient.

As for SSL high concentration of either PSL or STS causes turbidity or clouding.

| | STS Q | | | | | |
|---|---|---|---|---|---|---|
| PSL 2671/051 | 0% | 0.02% | 0.04% | 0.06% | 0.08% | 0.10% |
| 0% | 4 | 5 | 6 | 6 | 7 | 7 |
| 0.0020% | 4 | 7 | 9 | 9 | 10 | 3 |
| 0.0050% | 4 | 7 | 10 | 10 | 3 | 3 |
| 0.0100% | 4 | 7 | 3 | 3 | 3 | 3 |

### Example 12

In the following example sodium lauroyl lactylate (SLL) was used in combination with sorbitan tristearate (GRINDSTED STS Q) and was incorporated into an oil which was 50:50 blend of palm olein have a cloud point of 5° C. and rape seed oil. The samples were tested at 12° C.

Procedure:

The samples were prepared in the same manner as Example 10.

| | STS Q | | |
|---|---|---|---|
| SLL | 0% | 0.02% | 0.04% |
| 0% | 3 | 7 | 6 |
| 0.0020% | 3 | 15 | 19 |
| 0.0050% | 5 | 14 | 6 |
| 0.0100% | 9 | 32 | >35 |
| 0.0200% | 11 | >35 | >35 |

A clear effect is seen with SLL added as single ingredient as well as together with STS Q. The optimal dosage range is slightly higher than for SSL.

### Example 13

In the following example sodium behenoyl lactylate (SBL) was used in combination with sorbitan tristearate (GRINDSTED STS Q) and was incorporated into an oil which was 50:50 blend of palm olein have a cloud point of 5° C. and rape seed oil. The samples were tested at 12° C.

Procedure:

The samples were prepared in the same manner as Example 10.

| | STS Q | | |
|---|---|---|---|
| SBL | 0% | 0.02% | 0.04% |
| 0% | 3 | 7 | 6 |
| 0.0020% | 3 | 7 | 12 |
| 0.0050% | 7 | 19 | 22 |
| 0.0100% | 9 | >35 | >35 |
| 0.0200% | 9 | 6 | 6 |

A clear effect is seen with SBL added as single ingredient as well as together with STS Q. Optimal dosage range as for SSL/STS combinations.

### Example 14

In the following example different blends of sodium stearoyl-2-lactylate (SSL) and sodium palmitoyl lactylate (SPL) was used in combination with sorbitan tristearate (GRINDSTED STS Q) and was incorporated into an oil which was 50:50 blend of palm olein have a cloud point of 5° C. and rape seed oil. The samples were tested at 12° C.

Procedure:

The samples were prepared in the same manner as Example 10.

| SPL:SSL | Amount of | STS Q | | |
|---|---|---|---|---|
| ratio | blend | 0% | 0.02% | 0.04% |
| | 0.0000% | 3 | 8 | 18 |
| 100:0 | 0.0020% | 3 | 8 | 19 |
| 100:0 | 0.0050% | 5 | 19 | 11 |
| 100:0 | 0.0100% | 12 | 17 | 9 |
| | 0.0000% | 3 | 8 | 18 |
| 75:25 | 0.0020% | 4 | 11 | 22 |
| 75:25 | 0.0050% | 7 | 17 | 10 |
| 75:25 | 0.0100% | 13 | 17 | 17 |
| | 0.0000% | 3 | 8 | 18 |
| 50:50 | 0.0020% | 3 | 10 | 20 |
| 50:50 | 0.0050% | 5 | 20^{†} | 20^{†} |
| 50:50 | 0.0100% | 18 | 7 | 6 |
| | 0% | 7 | 11 | 13 |
| 30:70 | 0.0020% | 6 | 24 | 23 |
| 30:70 | 0.0050% | 7 | 32 | 29 |
| 30:70 | 0.0100% | 21 | 44 | 35 |
| | 0.0000% | 3 | 8 | 18 |
| 25:75 | 0.0020% | 4 | 10 | 30 |
| 25:75 | 0.0050% | 6 | 14 | 10 |
| 25:75 | 0.0100% | 11 | 7 | 5 |
| | 0.0000% | 3 | 8 | 18 |
| 0:100 | 0.0020% | 5 | 9 | 11 |
| 0:100 | 0.0050% | 7 | 32 | 13 |
| 0:100 | 0.0100% | 15 | 6 | 4 |

A further subtrial was performed using a 100% palm olein with better cold stability properties.

Best results are seen with a fatty acid composition with at least 50% by weight of C18 based on the total amount of fatty acids. However for the 50:50 blends the two samples marked † were actually much better than the results indicate. A few crystals appeared after 20 days, but no more crystallisation is seen even after 34 days. This means the best range for the fatty acid composition is from 50% C18 and up including 50% in the range.

### Example 15

In the following example sodium oleoyl lactylate (SOL) was used in combination with sorbitan tristearate (GRINDSTED STS Q) and was incorporated into an oil which was 50:50 blend of palm olein having a cloud point of 5° C. and rape seed oil. The samples were tested at 12° C.

Procedure:

The samples were prepared in the same manner as Example 10.

| | |
|---|---|
| SOL | STS Q |

| (2440/207) | 0% | 0.02% | 0.04% | 0.06% |
|---|---|---|---|---|
| 0% | 4 | 8 | 15 | 11 |
| 0.0020% | 4 | 8 | 12 | 11 |
| 0.0050% | 5 | 15 | 26 | 18 |
| 0.0100% | 6 | 27 | 24 | 25 |
| 0.0150% | 6 | 27 | 46 | 26 |
| 0.0200% | 6 | 31 | 41 | 45 |
| 0.0250% | 6 | 34 | 54 | 54 |

2440/207: approx 34% lactic acid and based on Palmac 760 fatty acids (min 75% oleic acid).

SOL is very effective in combination with STS Q with optimal dosage range 0.015-0.025% for SOL and for STS Q in the range 0.04-0.06%. Note that SOL requires slightly higher dosage than SSL when combined with STS Q.

### Example 16

In the following example SSL was incorporated into an oil which was 30:70 blend of palm olein having a cloud point of 5° C. and rape seed oil. The test was performed as follows:

Procedure:

Heat oil blend with emulsifiers to 130° C. (cabinet 200° C.).

Filter (Whatmann filter paper 115).

Fill 225 g in suitable blue cap bottle.

Cool to 25° C. in water bath.

Place samples in ice water and inspect for turbidity and crystallisation for 5.5 h.

| | SSL P 55 | | |
|---|---|---|---|
| Time h | 0.0010% | 0.005% | 0.010% |
| 0.5 | clear | Clear | clear |
| 1 | clear | Clear | clear |
| 1.5 | slightly turbid | Clear | clear |
| 2 | turbid | slightly turbid | clear |
| 2.5 | turbid | Turbid | clear |
| 3 | very turbid | very turbid | clear |
| 4 | very turbid | very turbid | clear |
| 4.5 | very turbid | very turbid | clear |
| 5 | pasty (more than 0.005%) | very very turbid | clear |
| 5.5 | pasty (more than 0.005%) | very very turbid | clear |

### Example 17

Experimental Procedure

1% (concentrate) solutions of both GRINDSTED STS Q and SSL (sample 1830/107) so were prepared by weighing the required amount of emulsifier and adding to the oil blend under agitation. The mixture was heated to 70° C. by which time the emulsifiers had dissolved yielding a homogeneous, clear solution of each emulsifier, These solutions were held warm to maintain them as solutions.

To prepare each test sample, the required mass of emulsifier concentrate was added into a beaker, and oil blend added to make a 200 g total. The mixture was heated to 70° C., producing a clear solution.

150 g of the solution was transferred to a test bottle (200 mL “McCarthy” bottle), and the bottle capped and labelled.

Once all test bottles had been prepared they were transferred to a 75° C. water bath and held for 2 hours. The bottles were then transferred to the lab bench at room temperature for 90 minutes following which they were transferred to a 12° C. water bath. Samples were observed daily and failure date recorded.

Results

| | | % STS | % | Failure | |
|---|---|---|---|---|---|
| Bottle # | Anti Cryst. | Q | 1830/107 | days | How failed |
| 1 | | 0 | 0 | 1 | Dusting |
| 2 | STS | 0.02 | 0 | 4 | Crystallisation |
| 3 | STS | 0.04 | 0 | 6 | Sl. Turbid |
| 4 | STS | 0.06 | 0 | 1 | Cloudy |
| 5 | STS | 0.08 | 0 | 1 | Cloudy |
| 6 | STS | 0.1 | 0 | 1 | Cloudy |
| 8 | 1830/107 | 0 | 0.01 | 1 | Dusting |
| 9 | 1830/107 | 0 | 0.015 | 1 | Dusting |
| 10 | 1830/107 | 0 | 0.02 | 4 | Crystallisation |
| 11 | 1830/107 | 0 | 0.025 | 12 | Crystallisation |
| 12 | 1830/107 | 0 | 0.03 | 19 | Crystallisation |
| 13 | 1830/107/STS | 0.02 | 0.01 | 8 | Nucleation |
| 14 | 1830/107/STS | 0.02 | 0.015 | 13 | Crystallisation |
| 15 | 1830/107/STS | 0.02 | 0.02 | 42 | Crystallisation |
| 16 | 1830/107/STS | 0.02 | 0.025 | >57 | |
| 17 | 1830/107/STS | 0.02 | 0.03 | >57 | |
| 18 | 1830/107/STS | 0.04 | 0.01 | 15 | Crystallisation |
| 19 | 1830/107/STS | 0.04 | 0.015 | 42 | Crystallisation |
| 20 | 1830/107/STS | 0.04 | 0.02 | 35 | Crystallisation |
| 21 | 1830/107/STS | 0.04 | 0.025 | 39 | Crystallisation |
| 22 | 1830/107/STS | 0.04 | 0.03 | 1 | Crystallisation |
| 23 | 1830/107/STS | 0.06 | 0.01 | 1 | Cloudy |
| 24 | 1830/107/STS | 0.06 | 0.015 | 7 | Sl. Cloud |
| 25 | 1830/107/STS | 0.06 | 0.02 | 25 | Dusting |
| 26 | 1830/107/STS | 0.06 | 0.025 | 25 | Dusting |
| 27 | 1830/107/STS | 0.06 | 0.03 | >57 | |
| 28 | 1830/107/STS | 0.08 | 0.01 | 1 | Cloudy |
| 29 | 1830/107/STS | 0.08 | 0.015 | 4 | Cloudy |
| 30 | 1830/107/STS | 0.08 | 0.02 | 41 | |
| 31 | 1830/107/STS | 0.08 | 0.025 | 29 | Cloudy |
| 32 | 1830/107/STS | 0.08 | 0.03 | 55 | Cloudy |
| 33 | 1830/107/STS | 0.1 | 0.01 | 1 | Cloudy |
| 34 | 1830/107/STS | 0.1 | 0.015 | 1 | Cloudy |
| 35 | 1830/107/STS | 0.1 | 0.02 | 6 | Sl. Turbid |
| 36 | 1830/107/STS | 0.1 | 0.025 | 1 | Crystallisation |
| 37 | 1830/107/STS | 0.1 | 0.03 | 26 | Clouding |

Conclusion

40% lactic acid SSL was found to have an effect in its own right, particularly at concentrations >0.02%. It was superior to STS by itself, which had a maximum performance of 6 days in this experiment.

The combination demonstrated a synergy of effect, with several combinations providing clarity for >57 days.

### Example 18

In the following example sodium stearoyl-2-lactylate (GRINDSTED SSL P55) alone and in combination with a polyglycerol ester (PGE) was incorporated into a 50:50 blend of palm olein cooking and rape seed oil.

The PGE was a decaglycerol ester in which >95% of all hydroxyl groups are esterified, the predominant fatty acid component is C16. The PGE has an acid value of <10 mg KOH/g and a hydroxyl value of <12 mg KOH/g.

The samples of cooking oil were made in accordance with Example 2.

| | | 50:50 Blend (palm olein Cp 5° C.: rape | | | |
|---|---|---|---|---|---|
| | 12° C. | seed oil) | | | |
| | PGE | | | | |
| SSL P55 | 0% | 0.04% | 0.06% | 0.08% | 0.10% |
| 0% | 3 | 17& | 17& | 18& | 18& |
| 0.0020% | 3 | 12 | 12 | 18† | 32 |
| 0.0050% | 5 | 28 | 58 | 58 | >76 |
| 0.0100% | 10 | 45 | 31 | >76 | >76 |

&denotes that the sample showed clouding after 6 days.
†denotes that the sample showed clouding after 15 days.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. A palm olein composition comprising:
(a) palm olein oil and
(b) (i) a lactic acid ester selected from the group consisting of an ester of lactic acid and a C12 to C22 fatty acid, salts thereof and mixtures thereof; or
(ii) a fumaric acid ester selected from the group consisting of an ester of fumaric acid and a C12 to C22 fatty alcohol, salts thereof, and mixtures thereof.

2. A palm olein composition according to claim 1 comprising
a lactic acid ester selected from the group consisting of an ester of lactic acid and a C12 to C22 fatty acid, salts thereof, and mixtures thereof.

3. A palm olein composition according to claim 2 wherein the fatty acid ester is C12 to C22 fatty acid.

4. A palm olein composition according to claim 2 wherein the fatty acid is a C18 to C22 fatty acid.

5. A palm olein composition according to claim 2 wherein the fatty acid is a C18 fatty acid.

6. (canceled)

1. A palm olein composition according to claim 2 wherein the fatty acid is a mixture of C16 and C18 fatty acid.

7. A palm olein composition according to claim 2 wherein the fatty acid is a saturated fatty acid.

8. A palm olein composition according claim 2 wherein the fatty acid is selected from the group consisting of palmitic acid, stearic acid, or a mixture thereof.

9. A palm olein composition according to claim 2 wherein the fatty acid is stearic acid.

10. A palm olein composition according to claim 1 comprising
a fumaric acid ester selected from the group consisting of an ester of fumaric acid and a C12 to C22 fatty alcohol, salts thereof, and mixtures thereof.

11. A palm olein composition according to claim 10 wherein the fatty alcohol is a C16 to C22 fatty alcohol.

12. A palm olein composition according to claim 10 wherein the fatty alcohol is a C18 to C22 fatty alcohol.

13. A palm olein composition according to claim 10 wherein the fatty alcohol is a C18 fatty alcohol.

14. A palm olein composition according to claim 10 wherein the fatty alcohol is a saturated fatty alcohol.

15. A palm olein composition according to claim 10 wherein the fatty alcohol is selected from the group consisting of palmityl alcohol, stearyl alcohol or a mixture thereof.

16. A palm olein composition according to claim 10 wherein the fatty alcohol is stearic alcohol.

17. A palm olein composition according to claim 1 wherein the lactic acid ester or fumaric acid ester is in the form of a sodium, calcium or potassium salt thereof.

18. A palm olein composition according to claim 17 wherein the lactic acid ester or fumaric acid ester is in the form of a sodium salt thereof.

19. A palm olein composition according to claim 2 wherein the lactic acid ester is sodium stearoyl lactylate.

20. A palm olein composition according to claim 1 wherein the palm olein oil is double fractionated.

21. A palm olein composition according to claim 1 wherein the lactic acid ester or fumaric acid ester is present in an amount of at least 0.001 wt % based on the weight of palm olein oil.

22. A palm olein composition according to claim 1 wherein the lactic acid ester or fumaric acid ester is present in an amount of at least 0.005 wt % based on the weight of palm olein oil.

23. A palm olein composition according to claim 1 wherein the lactic acid ester or fumaric acid ester is present in an amount of at least 0.01 wt % based on the weight of palm olein oil.

24. A palm olein composition according to claim 1 to 10 wherein the lactic acid ester or fumaric acid ester is present in an amount of no greater than 0.1 wt % based on the weight of palm olein oil.

25. A palm olein composition according to claim 1 wherein the lactic acid ester or fumaric acid ester is present in an amount of no greater than 0.04 wt % based on the weight of palm olein oil.

26. A palm olein composition according to claim 1 wherein the lactic acid ester or fumaric acid ester is present in an amount of no greater than 0.02 wt % based on the weight of palm olein oil.

27. A palm olein composition according to claim 1 wherein the composition further comprises (c) sorbitan tristearate.

28. A palm olein composition according to claim 27 wherein the sorbitan tristearate is present in an amount of at least 0.02 wt % based on the weight of palm olein oil.

29. A palm olein composition according to claim 27 wherein the sorbitan tristearate is present in an amount of at least 0.04 wt % based on the weight of palm olein oil.

30. A palm olein composition according to claim 27 wherein the sorbitan tristearate is present in an amount of at least 0.06 wt % based on the weight of palm olein oil,

31. A palm olein composition according to claim 27 wherein the sorbitan tristearate is present in an amount of at least 0.08 wt % based on the weight of palm olein oil.

32. A process for inhibiting crystallisation of triglyceride in palm olein oil, the process comprising the steps of:
(a) providing a palm olein oil and
(b) creating a combined palm olein oil by combining with the palm olein oil
(i) a lactic acid ester selected from the group consisting of an ester of lactic acid and a C12 to C22 fatty acid, salts thereof and mixtures thereof; or
(ii) a fumaric acid ester selected from the group consisting of an ester of fumaric acid and a C12 to C22 fatty alcohol, salts thereof, and mixtures thereof.

33. A process according to claim 32 further including the step of storing the combined palm olein oil at a temperature of less than 25° C.

34. A process according to claim 33 wherein the combined in palm olein oil is stored at a temperature of less than 15° C.

35. A process according to claim 32 wherein the palm olein oil is deodorised palm olein oil or refined palm olein oil.

37. (canceled)

36. A palm olein composition according to claim 1 wherein the composition further comprises (d) a second oil.

37. A olein composition according to claim 36 wherein the second oil is selected from the group consisting of moringa oil, soy oil, cottonseed oil, canola oil, rapeseed oil, peanut oil, rice bran oil, corn oil, safflower oil, sunflower oil, linseed oil, olive oil, peanut oil and mixtures thereof.

38. A palm olein composition according to claim 37 wherein the rapeseed oil is selected from the group consisting of high oleic rapeseed oil containing at least 82% oleic acid based on the total weight of fatty acids, low erucic acid rapeseed oil, and high erucic acid rapeseed oil.

39. A palm olein composition according to claim 37 wherein the rice bran oil is dewaxed rice bran oil.

40. A palm olein composition according to claim 37 wherein the sunflower oil is high oleic sunflower oil containing at least 82% oleic acid based on the total weight of fatty acids.

41. A process according to claim 32 further including the steps of
(c) providing a second oil and
(d) combining the second oil with the combined palm olein oil.

42. A process according to claim 41 wherein the second oil is selected from the group consisting of moringa oil, soy oil, cottonseed oil, canola oil, rapeseed oil peanut oil, rice bran oil, corn oil, safflower oil, sunflower oil, linseed oil, olive oil, peanut oil and mixtures thereof.

40. (canceled)

41. (canceled)

42. (canceled)

43. A process according to claim 32 further including the steps of
(e) providing a sorbitan tristearate and
(f) combining the sorbitan tristearate with the combined palm olein oil.

44. A process according to claim 32 further including the steps of
(c) providing a second oil,
(d) combining the second oil with the combined palm olein oil,
(e) providing a sorbitan tristearate and
(f) combining the sorbitan tristearate with the combined palm olein oil.

45. (canceled)
